(19) United States
(12) Patent Application Publication
(10) Pub. No.: US 2011/0124276 A1
(43) Pub. Date: May 26, 2011

(54) Link loader

(75) Inventors: Michael Wayne Waldrop, Houston, TX (US); Christopher Neil Waldrop, Houston, TX (US); Patrick Garinger, Bourbonnais, IL (US); Dan Sambrooks, Momence, IL (US); Donald Claussen, Grant Park, IL (US); Edward Petras, Kankakee, IL (US)

(73) Assignee: Momence Packing Co.

(21) Appl. No.: 12/592,381

(22) Filed: Nov. 24, 2009

(51) Int. Cl. A22C 17/00

(52) U.S. Cl. 452/51

(57) ABSTRACT

A device for loading link sausages into a tray package includes a first continuous conveyor adapted and constructed to transport sausage links. A continuous transfer belt receives sausages from the first continuous conveyor, and transfers them to a separation and placement device adapted and constructed to separate the sausages from the first continuous conveyor into discrete groups of pluralities of sausages, and to deposit the sausages received onto packaging trays. A second continuous conveyor transports loaded trays of sausage links away from the metering device.

### CROSS-REFERENCE TO RELATED APPLICATION

None.

### BACKGROUND OF THE INVENTION

The word “sausage” has its root in Latin word calsus, which means salted or preserved, but the history of sausages themselves predates the Roman Empire. The history of sausage production parallels the recorded history of man and civilization. Sumeria is cited as the first place where sausages appeared around 3000 B.C., and Chinese sausage, first appearing around 589 B.C, was made from lamb or goat meat. Sausages have been so much a part of human culture that they are mentioned in literature of almost every society, from Horner to Dickens, Sartre, Dostoevsky, and Hemingway.

For at least the last millennium, sausage making evolved into a venerable and highly developed craft. In many cases, families handed down their particular sausage making art over several generations and across dozens of nations, with each “wurstmacher” contributing his taste and heritage to the art. Of course, the art was also influenced by the demand of the marketplace and by the availability of the various ingredients which went into the sausage.

In the last century, the advent of refrigerated transportation and processing technology fostered mass production of myriad food products, sausages among them. Speed and consistency joined quality as the goal of sausage producers, and commercial sausage making became a highly specialized business.

Despite the mechanization of the sausage making process, many aspects of processing and packing sausages are still commonly accomplished by hand. Since the speed of a line is limited by its slowest function, it is desirable to automate product handling whenever practical. This is of particular importance in the handling of sausages in a packing system.

Handling systems for these and other purposes have been the subject of a high degree of inventive activity, as evidenced by the patent literature. For example, U.S. Pat. No. 4,633,652 to Dagenais discloses a method and apparatus for automatically packing sausage links in containers. A high speed feed conveyor feeds a plurality of spaced apart sausage links, in a lengthwise orientation, to a further conveyor having a plurality of transverse compartments. A sausage link is received in each compartment and their arc conveyed transversewise, in side-by-side relationship, to a group forming station. Sensing devices are provided to determine when a predetermined quantity of sausage links are at the forming station. A movable platform then displaces the sausage links from the group forming station to an unloading station where they are reoriented in side-by-side contact relationship and unloaded into a container by a pusher mechanism. While the group of sausage links is being unloaded, another group is being formed at the forming station.

U.S. Pat. No. 4,733,518 to Griesdorn discloses an apparatus for packaging articles of roughly equal size in package means therefor and method of making such apparatus are provided wherein such apparatus comprises a first conveyor device for the articles with the first conveyor device having a plurality of receptacles each for receiving and supporting an individual one of the articles, a second conveyor device for moving a plurality of packages for the articles, and a transfer device for transferring a predetermined number of the articles from the first conveyor device into associated packages therefor wherein the first and second conveyor devices have portions thereof in parallel facing relation and the apparatus further comprises a drive for operating the conveyor devices in a continuous non-indexing manner to thereby continuously package the predetermined number of articles in an associated package. In accordance with another feature of this invention the apparatus comprises an improved transfer device in the form of a rotatable star wheel and cooperating stationary fingers with the star wheel having a plurality of radial arms which are adapted to extend through selected fingers and cooperate therewith to transfer articles.

See also U.S. Pat. No. 4,344,523 to May, showing an apparatus for accumulating and stacking articles, such as sausages or other food products, in cylindrical shaped casings, includes a conveyor moving the articles in groups to positions where portions of the group are removed by a conveyor to positions from which they are further moved into a conveyor having carriages receiving a group portion as a lower tier of a stack thereof and subsequently receiving another group portion as an upper tier.

Further, see U.S. Pat. No. 6,779,647 to Nagler teaches a method for automatically grouping articles, the articles are moved on a belt to a manipulation device for grouping the articles in a predetermined order to form an assortment. Orientation and position of the articles on the belt are detected by a recognition device. A manipulation position based on the orientation and position detected by the recognition device, the belt speed, and the number of articles on the belt leading and/or trailing each article is determined for each article. The manipulation position is an assigned position in the assortment or an advanced or pushed-back position in the feeding direction. The advanced position or the pushed-back position is assigned when the number of articles leading and/or trailing each article is smaller than the predetermined number of the assortment. The manipulation device moves the articles into the manipulation position as soon as the articles reach its gripping range.

Additionally, see U.S. Pat. No. 6,374,984 Nagler is directed to a method for automated grouping of objects, in which the objects are randomly placed onto a conveyor belt and transported in a steady conveying flow to a grouping device. A recognition device determines a location and a position of the objects transported on the conveyor belt before reaching the grouping device and communicates the location and the position of the objects to a control unit. The control unit evaluates the random ordered state of the objects on the conveyor belt based on the location and the position of the objects. The control unit determines, based on the evaluation result of the evaluating step, sorting positions on the conveyor belt. The handling device groups, taking into account the belt speed, the objects in a group on each one of the determined sorting positions on the conveyor belt. The groups of objects are then further transported on the conveyor belt.

Moreover, see U.S. Pat. No. 5,388,385 Phelps, which discusses a filling head for loading food articles such as franks into individual packaging trays that is adapted for quick connect to a power system and a loader parent machine. The filling head comprises an open frame, at least two spring loaded flapper doors hingeably attached to the frame, and a pusher bar unloading system capable of operable connection to the power system of the parent machine to intermittently discharge food articles from the filling head to the individual packaging trays positioned below the flapper doors. The pusher bar unloading system includes a drive rod which can be connected to the periphery of a flywheel by quick connect means to run in an smooth continuous reciprocating motion to deliver an up and down motion to a horizontal shaft slideably mounted on the frame and an associated set of pusher bars and elongated pusher members. The elongated pusher members at the bottom of the drive rod stroke forces food articles in the filling head to open the flapper doors and drop the food articles into the packaging trays. The filling head has quick connect features which allows the use of different filling heads constructed to deliver different food article arrangements into packaging trays.

Additionally, see U.S. Pat. No. 5,057,055 Michaud for a sausage link handling and packaging machine which comprises a feed conveyor for receiving individual sausage links from a link forming machine and for transferring them onto a main conveyor. These sausage links are transferred in a guided manner whereby to orient them on a predetermined ejecting path. When the sausage links arrive at the receiving end of the main conveyor, they are oriented in a side-by-side transverse alignment relationship. A transfer device is provided at a transfer station along the main conveyor to transfer a predetermined number of the transversely aligned sausage links off the conveyor and onto a package support element. The package support element with the predetermined number of sausage links thereon are then conveyed downstream of the transfer station for further handling.

### SUMMARY

A device for loading link sausages into a tray package includes a first continuous conveyor adapted and constructed to transport sausage links. A continuous transfer belt receives sausages from the first continuous conveyor, and transfers them to a separation and placement device adapted and constructed to separate the sausages from the first continuous conveyor into discrete groups of pluralities of sausages, and to deposit the sausages received onto packaging trays. A second continuous conveyor transports loaded trays of sausage links away from the metering device.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 illustrates a perspective view of an embodiment of a device for loading link sausages in accordance with the principles of the present invention.

FIG. 2 illustrates another perspective view of an embodiment of a device for loading link sausages in accordance with the principles of the present invention.

FIG. 3 illustrates a schematic diagram of a device for loading link sausages in accordance with the principles of the present invention.

FIG. 4 illustrates a schematic diagram of the functioning of a placement device in a first position.

FIG. 5 illustrates a schematic diagram of the functioning of a placement device in a second position.

### DETAILED DESCRIPTION OF EMBODIMENTS OF THE INVENTION

In the following description, specific details are set forth in order to provide a thorough understanding of the invention. However, it will be apparent that the invention may be practiced without these specific details. Without departing from the generality of the invention disclosed herein and without limiting the scope of the invention, the discussion that follows will refer to the invention as depicted in the drawings.

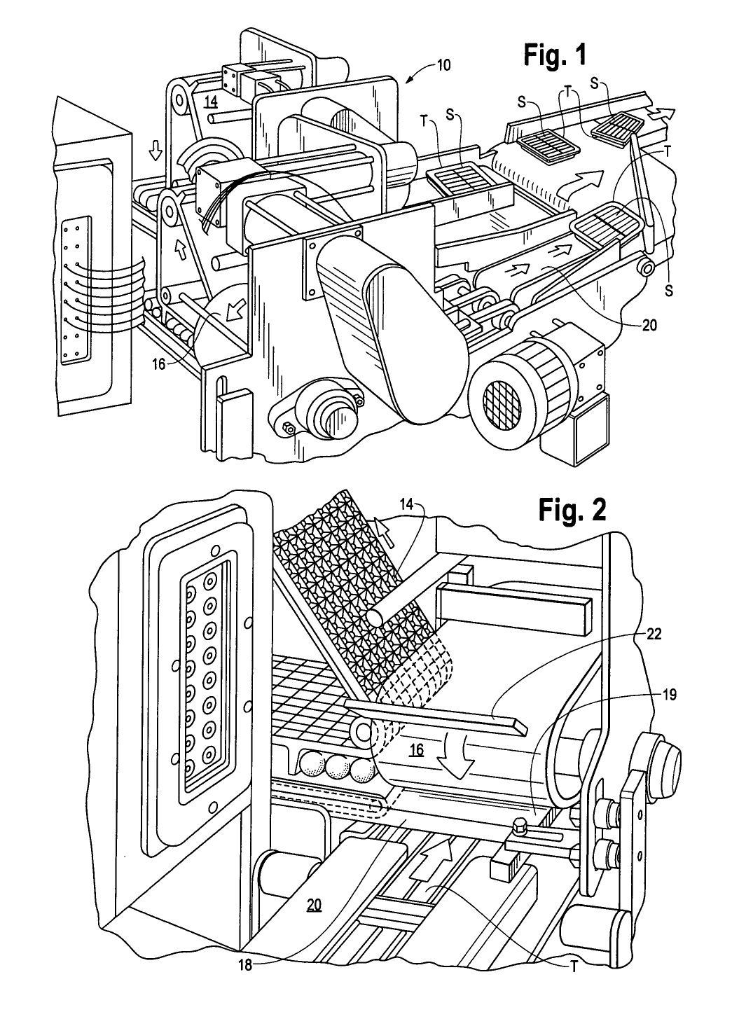

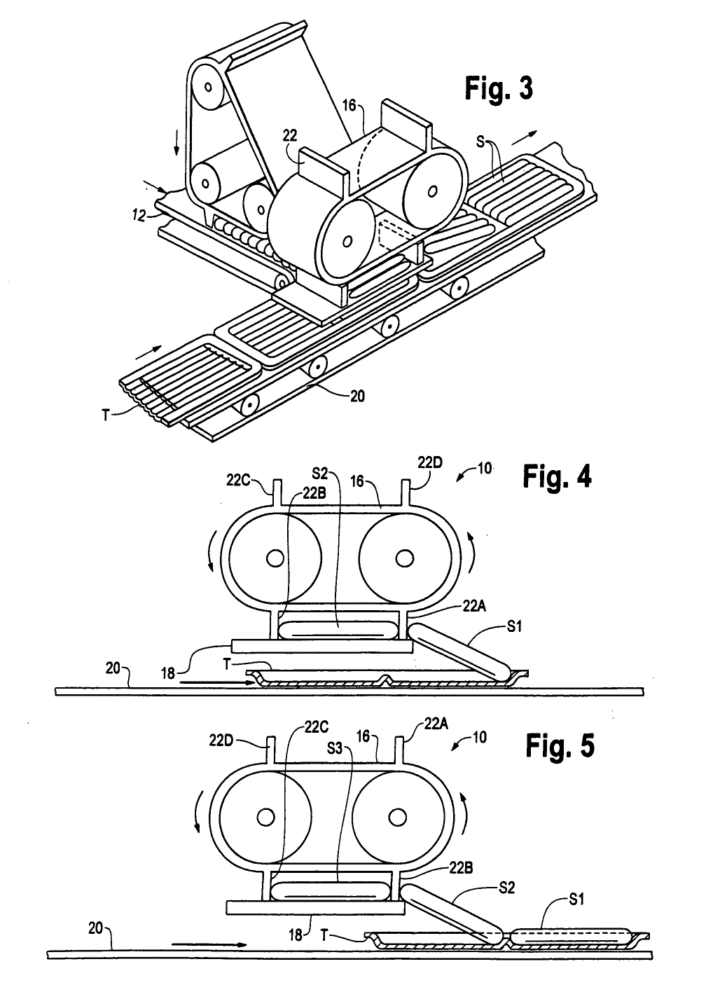

A device 10 for loading link sausages into a tray package is shown generally in FIGS. 1 through 3. The device 10 includes a first generally horizontal and continuous conveyor 12 that conveys sausage links from upstream stations at which the sausage links are formed. The first conveyor 12 transports the sausages to an angled continuous transfer belt 14. The sausages S to be packaged are oriented generally crosswise to the direction of travel of the transfer belt 14, and the transfer belt 14 has a width substantially greater than a length of the sausages.

From the transfer belt 14, sausages are moved downwardly to a dispensing platform 18, where their movement is halted by a stop ledge 19. At this point, the sausages are separated into discrete groups of pluralities of sausages by a generally horizontal separation and placement device 16, provided as a continuous belt. The number of sausages in each discrete group is chosen to correspond to the configuration and capacity of the packages into which the sausages are to be placed. In the illustrated example, the sausages are separated into discrete groups of seven sausages. The separation and placement device 16 separates the sausages into discrete groups by means of a plurality of spaced paddles 22 extending outwardly from an outer surface of the continuous belt of the separation and placement device 16 at regular intervals. The paddles 22 are evenly spaced from one another on the separation and placement device 16 by a distance approximately equivalent to the width of a group of seven sausage links. Once the sausages are in place on the dispensing platform 18, the separation and placement device 16 is incrementally advanced to push each discrete group of sausages forward and into a packing tray T beneath the platform 18. Once the tray T has been loaded with the requisite number of sausages, the filled trays are transported by generally horizontal conveyor 20 for further packing steps.

The transfer belt 14, loading platform and stop ledge 19, and separation and placement device 16 are fabricated from a durable material suitable for food contact. Examples of such materials include stainless steel, and plastic materials such as HDPE.

Operation of the device 10 can be seen in FIGS. 4 and 5. In FIG. 4, paddles 22A, 22B, and 22C of the separation and placement device 16 have separated the sausages received from the transfer belt 14 into discrete groups of sausages S1 and S2 on the loading platform 18. A tray T adapted to accommodate 14 sausage links is moved into place beneath the platform 18 by the belt 20.

As seen in FIG. 5, the separation and placement device 16 is actuated by a control system (not shown) to move a distance approximately equal to the spacing between the paddles 22. This movement causes a discrete group of sausages S1 to move forward in the direction of the arrow A, and fall into place in the tray T. In the illustrated example, the tray T is adapted to hold 14 sausages in two rows. In order to achieve this configuration, the separation and placement device 16 and the belt 20 are advanced in a coordinated manner. The belt 20 moves a forward part of the tray partially forward of the edge of the platform 18, and the separation and placement device 16 is advanced to place a first row of sausages. The belt 20 is then advanced so that a rearward part of the tray is partially forward of the edge of the platform 18, and the separation and placement device 16 is advanced to place a second group of sausages in a second row. This process is repeated as desired for a production run.

While this invention has been described in connection with the best mode presently contemplated by the inventor for carrying out his invention, the embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The invention resides not in any one of these features per se, but rather in the particular combinations of some or all of them herein disclosed and claimed and it is distinguished from the prior art in these particular combinations of some or all of its structures for the functions specified.

With respect to the above description then, it is to be realized that the optimum dimensional relationships for the parts of the invention, including variations in size, materials, shape, form, function and manner of operation, assembly and use, and all equivalent relationships to those illustrated in the drawings and described in the specification, that would be deemed readily apparent and obvious to one skilled in the art, are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim as our invention:

1. A device for loading link sausages into a tray package, the device comprising the following:
a first continuous conveyor adapted and constructed to transport sausage links;
a transfer belt adapted and constructed to transfer sausages from the first continuous conveyor;
a separation and placement device adapted and constructed to receive sausages from transfer belt, separate the sausages from transfer belt into discrete groups of pluralities of sausages, and place the discrete groups onto a tray package; and
a second continuous conveyor adapted and constructed to transport loaded trays of sausage links away from the separation and placement device.

2. A device in accordance with claim 1, wherein the first continuous conveyor and the separation and placement device are substantially horizontal.

3. A device in accordance with claim 2, wherein the first continuous conveyor is located above the separation and placement device.

4. A device in accordance with claim 3, wherein the transfer belt slopes downwardly from the first continuous conveyor to the separation and placement device.

5. A device in accordance with claim 1, wherein the separation and placement device comprises a continuous belt.

6. A device in accordance with claim 5, further comprising a plurality of transverse paddles extending outwardly from an outer surface of the continuous belt of the separation and placement device.

7. A device in accordance with claim 6, wherein the transverse paddles are located at evenly-spaced intervals.

8. A device in accordance with claim 7, wherein the interval spacing of the transverse paddles corresponds to a width of the discrete groups of pluralities of sausages.

9. A device in accordance with claim 1, wherein the transfer belt has a width substantially greater than a length of the sausages.

10. A device in accordance with claim 9, wherein the transfer belt is oriented so that the sausages to be packaged are oriented generally crosswise to a direction of travel of the transfer belt.

11. A device in accordance with claim 1, wherein the placement device and the transfer belt are fabricated from a material suitable for food contact.

12. A device in accordance with claim 10, wherein the separation and placement device and the transfer belt are fabricated from a plastic material.

13. A device in accordance with claim 1, wherein the placement device and the transfer belt are fabricated from HDPE.

14. A device in accordance with claim 10, wherein the separation and placement device and the transfer belt are fabricated from stainless steel.

15. A device for loading link sausages into a tray package, the device comprising the following:
a first generally horizontal continuous conveyor adapted and constructed to transport sausage links;
a sloped transfer belt adapted and constructed to transfer sausages from the first continuous conveyor;
a separation and placement device adapted and constructed to receive sausages from transfer belt, separate the sausages from transfer belt into discrete groups of pluralities of sausages, and place the discrete groups onto a tray package; and
a second continuous conveyor located beneath the separation and placement device, the second continuous conveyor being adapted and constructed to place the tray packages beneath the separation and placement device for loading, and to transport loaded trays of sausage links away from the separation and placement device.

16. A device in accordance with claim 15, wherein the first continuous conveyor is located above the separation and placement device.

17. A device in accordance with claim 16, wherein the transfer belt slopes downwardly from the first continuous conveyor to the separation and placement device.

18. A device in accordance with claim 15, wherein the separation and placement device comprises a continuous belt having a plurality of transverse paddles extending outwardly therefrom at evenly-spaced intervals.

19. A method for loading link sausages into a tray package, the method comprising the following steps:
providing a first continuous conveyor adapted and constructed to transport sausage links;
providing a transfer belt adapted and constructed to transfer sausages from the first continuous conveyor;
providing a separation and placement device adapted and constructed to receive sausages from transfer belt, separate the sausages from transfer belt into discrete groups of pluralities of sausages, and place the discrete groups onto a tray package;
providing a second continuous conveyor adapted and constructed to transport loaded trays of sausage links away from the separation and placement device;
actuating the first conveyor to transport sausages to the transfer belt;
actuating the transfer belt to transfer sausages from the first continuous conveyor to the separation and placement device; and
actuating the separation and placement device to separate the sausages from transfer belt into discrete groups of pluralities of sausages, and to place a first discrete group of sausages onto a first tray package.

20. A method in accordance with claim 19, further comprising the step of actuating the separation and placement device to separate the sausages from transfer belt into discrete groups of pluralities of sausages, and to place a second discrete group of sausages onto the first tray package.
